(19) United States
(12) Patent Application Publication
(10) Pub. No.: US 2019/0029304 A1
(43) Pub. Date: Jan. 31, 2019

(54) IMPROVED PULSE PROCESSING AND PRODUCTS PRODUCED THEREFROM

(71) Applicant: Archer Daniels Midland Company, Decatur, IL (US)

(72) Inventor: Joe Richardson, Decatur, IL (US)

(21) Appl. No.: 16/071,587

(22) PCT Filed: Jan. 25, 2017
(86) PCT No.: PCT/US17/14934

§ 371 Date: Jul. 20, 2018

Related U.S. Application Data
(60) Provisional application No. 62/286,643, filed on Jan. 25, 2016.

(51) Int. Cl. A23L 33/185; A23L 11/00; A23L 11/30; A23L 33/00

(52) U.S. Cl. CPC A23L 33/185; A23L 33/40; A23L 11/33; A23L 11/05

(57) ABSTRACT

Improved methods for processing pulses are disclosed. Products produced from such improved methods are further disclosed.

### TECHNICAL FIELD

The present invention relates generally to food technology and more particularly, to food products produced from pulses.

### BACKGROUND

Consumers searching for more health and wellness in their diets are turning to pulses. Pulses, which include edible beans, lentils, and peas, are high in protein and fiber and have been growing in popularity. As the worldwide demand for protein continues to grow, pulses are proving to be a cost effective alternative to the other more costly traditional proteins such as meat, fish, and dairy.

While other foods are high in protein, some of them suffer from the drawback of being listed as an allergen. For instance, dairy, soybeans, and peanuts, while providing a high quality protein, are considered to be “major food allergens” and are required to be listed on food labels containing such ingredients. This is one reason the food industry is searching for alternative non-meat proteins.

Thus, a need exists for new food ingredients that are good sources of protein and fiber, yet that are not allergens and are cost effective.

### SUMMARY

In each of its various embodiments, the present invention fulfills this need and discloses processes for producing pulse products that are functional as a food ingredient, yet provides the nutritional value of pulses.

In one embodiment, a process for producing a product comprises homogenizing a slurry comprising water and a comminuted pulse, and mixing an enzyme with the slurry.

In a further embodiment, a process for producing a pulse product comprises producing a slurry with a comminuted pulse and water, cooking the slurry, homogenizing the slurry, mixing an enzyme with the slurry, and inactivating the enzyme mixed with the slurry.

In another embodiment, products produced by the processes of the present invention are also disclosed.

In a further embodiment, food products incorporating products of the present invention are also disclosed.

In an additional embodiment, a homogenized, enzyme treated, comminuted pulse product comprises a particle size distribution having a mean particle size of less than 250 microns.

In one embodiment, a method of treating a person having dysphagia comprises feeding a homogenized, enzyme treated, comminuted pulse product of the present invention to the person having the dysphagia.

### DESCRIPTION OF THE DRAWINGS

FIG. 1 discloses one embodiment of a process of producing a pulse product of the present invention.

FIG. 2 discloses the viscosity of slurries containing various embodiments of the pulse products of the present invention.

FIG. 3 depicts the total sugar content and total DP2-DP10+ content of various pulse products produced using the present invention.

FIG. 4 shows the viscosity of slurries containing various embodiments of the pulse products of the present invention at different temperatures.

FIG. 5 illustrates the viscosity of slurries containing various embodiments of the pulse products of the present invention.

FIG. 6 shows the particle size distribution of various pulse products produced using the present invention.

FIG. 7 shows the color of an embodiment of producing a pulse of the present invention.

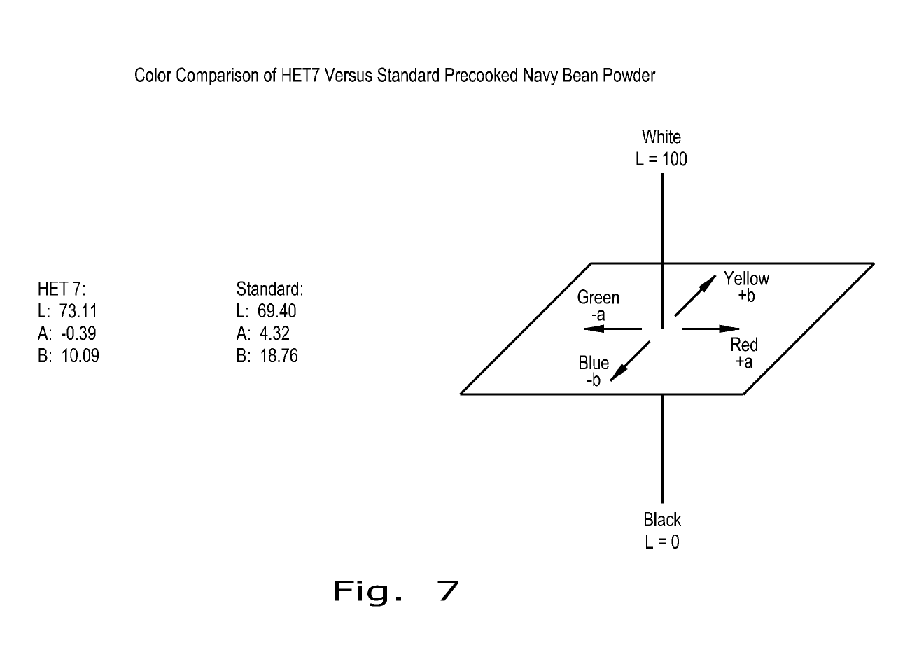

### DESCRIPTION OF THE INVENTION

In each of its various embodiments, the present invention discloses improved pulse processing, as well as products produced therefrom.

In one embodiment, a process for producing a product comprises homogenizing a slurry comprising water and a comminuted pulse, and mixing an enzyme with the slurry.

The process may also include inactivating the enzyme and may further include cooking the homogenized slurry and/or drying the slurry to a powder.

The comminuted pulse may be a pre-cooked, dehydrated pulse powder. In such embodiment, the process further comprises mixing the pre-cooked, dehydrated pulse powder with the water, thus producing the slurry.

The pulse powder may be present in the slurry of the process of the present invention at 5-50% solids, 10-40% solids, 10-15% solids, 15-35% solids, 15-25% solids, or about 20% solids.

In a further embodiment, the homogenizing may take place under pressure such as 2,000-15,000 psi, 5,000-10,000 psi, 8,000-10,000 psi, or about 10,000 psi.

The process may further include mixing a second enzyme with the slurry, wherein the second enzyme has a different activity than the enzyme. The process may further include homogenizing the slurry a second time after enzyme treatment.

The process may further include incubating the slurry and the enzyme and/or the second enzyme for a period of time. The temperature may be at least 35° C., at least 45° C., at least 55° C., 55-57° C., at least 65° C., between 50-90° C., 60-80° C., or about 70° C., and the incubating may occur for at least 5 minutes, at least 15 minutes, at least 25 minutes, at least 35 minutes, at least 45 minutes, at least 55 minutes, at least 65 minutes, at least 75 minutes, at least 85 minutes, between 45-135 minutes, between 55-125 minutes, between 65-115 minutes, between 75-105 minutes, between 85-95 minutes, or about 90 minutes.

In an embodiment, the enzyme has alpha-amylase activity and the second enzyme has xylanase activity.

The enzyme and/or the second enzyme may be inactivated by heating the slurry to a temperature of at least 70° C., at least 72° C., at least 74° C., at least 75° C., at least 76° C., at least 80° C., at least 85° C., at least 90° C., at least 93° C., or at least 95° C. Such inactivation may occur for a time of at least 30 seconds, at least 1 minute, at least 90 seconds, at least 2 minutes, at least 5 minutes, no more than 4 minutes, at least 10 minutes, at least 15 minutes, at least 20 minutes, at least 25 minutes, at least 30 minutes, at least 35 minutes, at least 40 minutes, at least 45 minutes, at least 50 minutes, at least 55 minutes, at least 60 minutes, at least 65 minutes, or at least 70 minutes.

In a further embodiment, the inactivating occurs for at least 30 seconds and a temperature of at least 90° C., for at least 45 minutes and a temperature of at least 74° C., for about 60 minutes at about 76° C., or for about one minute at about 93° C.

The process may further include holding the slurry, the enzyme, and/or the second enzyme at a temperature, such as between 30-70° C., between 35-65° C., between 40-60° C., between 45-55° C., or about 50° C.

In a further embodiment, drying the slurry to the powder may comprise spray draying, such as to less than 10% moisture. The spray drying may include an inlet temperature of between 500-520° F. and an outlet temperature of 185-200° F.

In yet a further embodiment, the process may further include hydrating the pulse powder and incorporating the hydrated powder into a food product or incorporating the pulse containing slurry into a food product.

In another embodiment, a second composition is homogenized with the water and the comminuted pulse. The second composition may be selected from the group consisting of a product of wheat, oat, sorghum, an ancient grain, corn, buckwheat, quinoa, chia, rice, barley, millet, rye, triticale, fonio, teff, wild rice, spelt, einkorn, emmer, durum, kamut, and combinations of any thereof.

Further embodiments include cooling the cooked slurry and/or filtering the slurry.

A product produced by any of the processes of the present invention is also disclosed.

In one embodiment, the pulse may be beans of a Phaseolus species, beans of a Vigna species, beans of Vicia species, peas, chickpeas, lentils, and combinations of any thereof.

In a further embodiment, a process for producing a pulse product comprises producing a slurry with a comminuted pulse and water, cooking the slurry, homogenizing the slurry, mixing an enzyme with the slurry, and inactivating the enzyme mixed with the slurry. The slurry may be further dried to a powder. The slurry may be cooled after cooking, and the slurry may be optionally filtered.

The process may further include mixing a second enzyme with the slurry, where the second enzyme has a different activity than the enzyme. After enzyme treatment, the slurry may be homogenized a second time. The enzyme may have amylase activity and the second enzyme may have xylanase activity.

The slurry may be produced by comminuting the pulse and placed such comminuted pulse in water.

The slurry may have a solids content of 10-30%. Inactivating the enzyme may include heating the slurry and the enzyme to a temperature sufficient to inactivate the enzyme. Drying the slurry may comprise spray drying the slurry.

In an additional embodiment, a homogenized, enzyme treated, comminuted pulse product has a particle size distribution having a mean particle size of less than 250 microns. The mean particle size may also be less than 200 microns, less than 150 microns, less than 100 microns, or less than 50 microns.

Upon dispersion of the homogenized, enzyme treated, comminuted pulse product in water, the dispersed, homogenized, enzyme treated pulse product has a lowered viscosity as compared to the comminuted, pulse product that has not been homogenized and enzyme treated.

The homogenized, enzyme treated, comminuted pulse product may also have less dietary fiber, more soluble fiber, less insoluble fiber, and combinations of any thereof as compared to the comminuted pulse product that has not been homogenized and enzyme treated.

A method of treating a person having dysphagia is further disclosed. Such method includes feeding one embodiment of a homogenized, enzyme treated, comminuted pulse product of the present invention to the person having dysphagia.

In an embodiment, the edible bean may be of a Phaseolus species (i.e., beans). In other embodiments, the pulse may comprise green or yellow peas (i.e., Pisum), green, red, or yellow lentils (i.e., Lens vulgaris), chickpeas or garbanzos, (i.e., Cicera arietenum), and combinations of any thereof. In further embodiments, varieties of beans that may be used to produce the pulse products of the present invention include, without limitation, Pinto beans, Great Northern beans, Navy beans, Red beans, Black beans, Black Turtle beans, dark or light Red Kidney beans, Fava beans, Green Baby Lima beans, Pink beans, MYASI beans, Mayocoba beans, Yellow beans, Peruvian beans, Small Red beans, Black Eyed beans, Cow peas, Garbanzo beans, Cranberry beans, White Beans, Rice beans, Butter beans, Pea beans, African Giraffe beans and any combinations thereof

In an embodiment, the comminuted pulse product may be produced using the process described in US Patent Application 2005/0095346 assigned to Archer-Daniels-Midland Company of Decatur, Ill., entitled Process for the Production of Reconstitutable Bean Products published May 5, 2005, the contents of the entirety of which is incorporated by this reference. In another embodiment, the process for dehydrating the pulse may include blanching the pulse or pulse product, cooking the blanched pulse or pulse product, and/or dehydrating the cooked pulse or pulse product to form a dehydrated or reconstitutable pulse or pulse product. In a further embodiment, water may be used to blanch and/or cook the pulse or pulse product, and an organic acid may optionally be added to the blanching water, the cooking water, or both.

In other embodiments, the process for producing the dehydrated pulse products includes conditioning the pulse by subjecting the pulse to hydration; cooking the pulse; depressurizing the cooked pulse; and/or dehydrating the pulse to form a reconstitutable pulse. In other embodiments, the process for dehydrating the pulse may also include use of an organic acid in the hydration, blanching, and/or cooking step, and the process may further include washing and/or destoning raw pulses used in the process.

The invention is further explained by use of the following exemplary embodiments.

### EXAMPLE 1

A pre-cooked, dehydrated Navy bean powder was mixed with water to produce a slurry at 20% weight/weight of the Navy bean powder. The Navy bean slurry was homogenized by being pumped through a GEA-Niro Souvi homogenizer at 8,000-10,000 psi. The homogenized Navy bean slurry was collected in containers. An enzyme was added to the homogenized, Navy bean slurry at a 0.04% dosage and allowed to incubate at about 70° C. for about 90 minutes. The enzyme used could by an alpha-amylase, a xylanase, or a combination thereof.

After the homogenized, Navy bean and enzyme slurry incubated, the slurry was heated to a temperature of greater than 75° C. (e.g., about 76° C.) and mixed for one hour to inactivate the alpha-amylase enzyme. The enzyme may also be inactivated by jet cooking the slurry at about 93° C. for one minute. The slurry was transferred to a sterile, jacketed surge tank and maintained at a temperature of about 50° C., during which time the slurry was pumped into a spray drier to produce a powdered product having a moisture content of about 9.1%. The spray drier has an inlet temperature of about 511° F. and an average outlet temperature of about 193° F.

### EXAMPLE 2

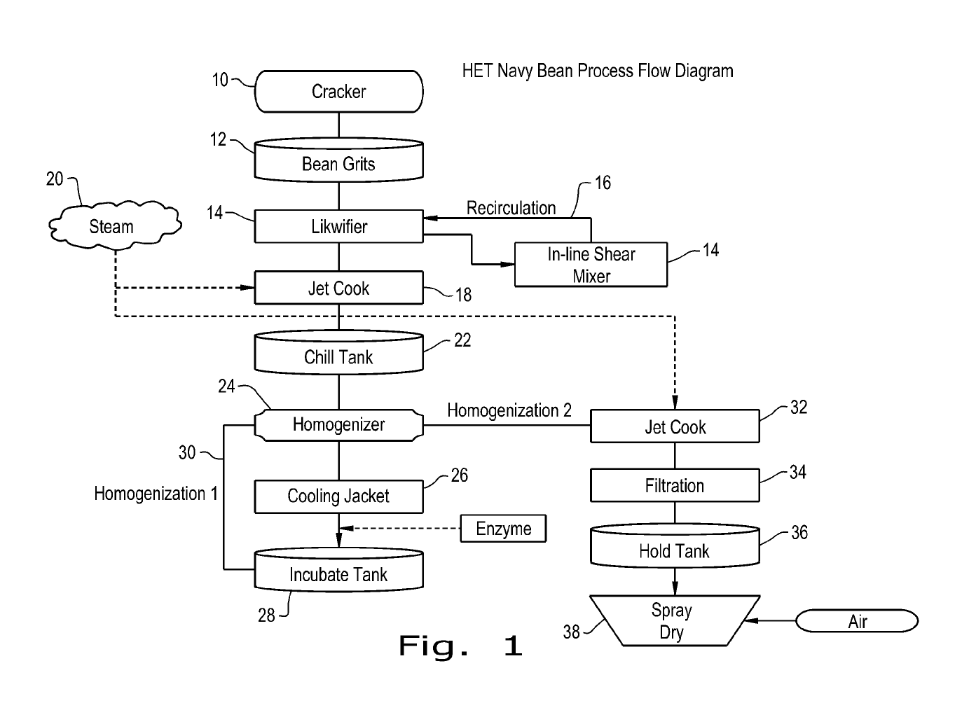

FIG. 1 shows a flowchart of one process used to produce the homogenized, enzyme treated pulses. Raw, Navy beans were cracked in a cracker at 10, thus producing Navy bean grits at 12. The Navy bean grits were placed in 90° C. water in a Likwifier blender at 14 and blended. The blended Navy bean grits were placed in an in-line shear mixer at 14 and re-circulated in the blender at 16 for no more than 45 minutes. The blended Navy bean grits may have 10-15% total solids at this point.

The sheared/blended Navy beans were jet cooked at 18 with steam at 221° F. for between about 2-4 minutes. The jet cooked Navy beans were passed through a chill tank at 22 to trim cool the jet cooked Navy beans to about 70-80° C. The cooled, jet cooked Navy beans were passed into a GEA brand NS3006L Panther homogenizer at 24 and homogenized at 10,000 PSI (about 800 bar). The homogenizer may also be a GEA brand Niro Soavi homogenizer. The homogenized Navy beans were transferred to a cooling jacket at 26 and cooled to about 47-53° C. The cooled, homogenized Navy beans were placed in a tank at 28 along with the amylase and the xylanase and incubated with agitation at about 55-57° C. for a minimum of about 45 minutes, or a time of about 1.5 hours. The enzyme treated Navy beans were transferred back to the homogenizer at 30 and homogenized. The enzyme treated, homogenized Navy beans were placed in a vessel and jet cooked at about 195° F. for no more than 4 minutes at 32 to de-activate the enzyme. The Navy beans were passed through a 150 micron sock filter at 34 into a hold tank at 36 jacketed with 70° C. water. The act of passing through the filter may be optional. The Navy bean slurry was spray dried at about 800° F. in a spray drier at 38 with an outlet temperature of about 194° F.

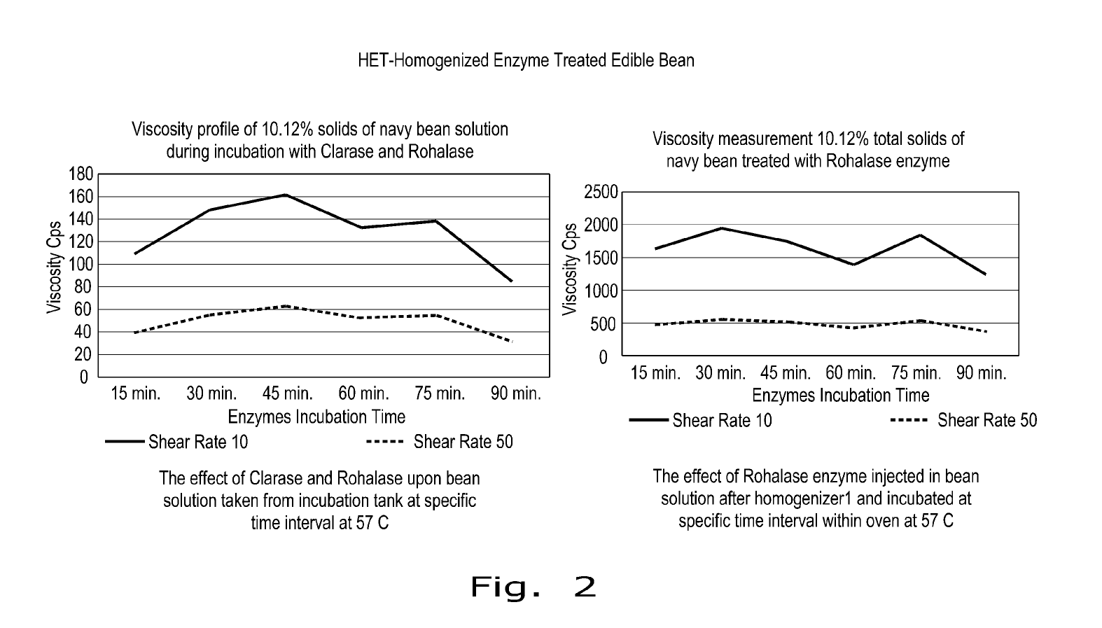

Viscosities of the homogenized, enzyme treated Navy beans were determined at various points during the process of Example 2. FIG. 2 illustrates the viscosities of the treated Navy beans upon treatment with the amylase and the xylanase and treatment with the amylase. As can be seen in FIG. 2, treating the Navy beans with the combination of the two enzymes resulted in a product with a lower viscosity as compared to treatment with the xylanase alone.

### EXAMPLE 3

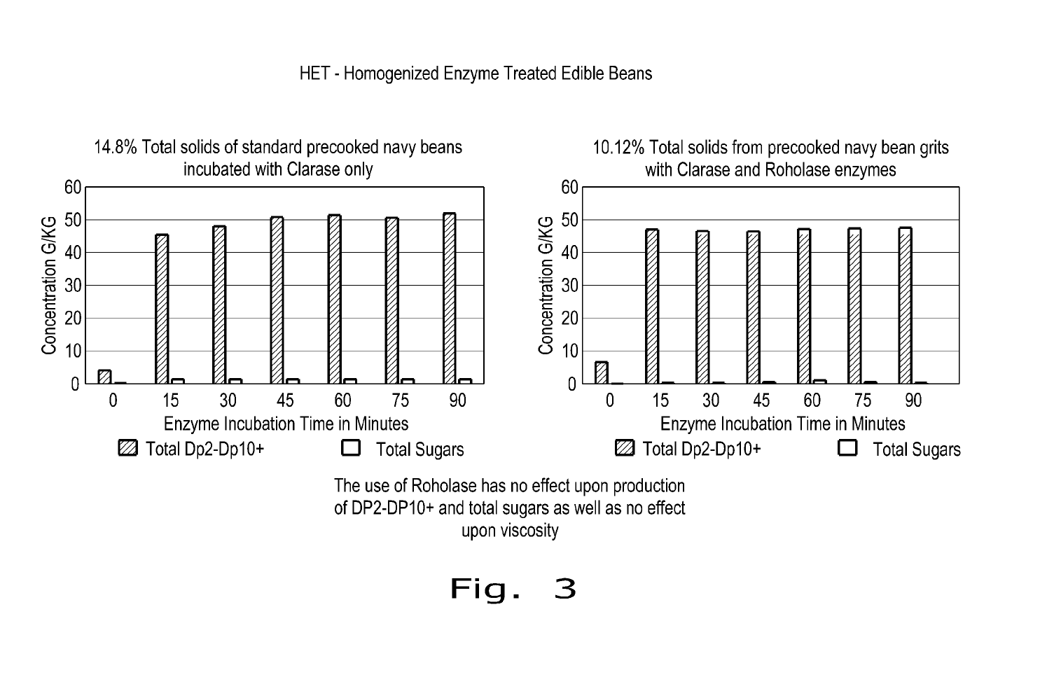

Pre-cooked Navy beans were processed according to Example 2 using a xylanase enzyme, and a combination of an amylase enzyme and a xylanase enzyme. The amylase was CLARASE L brand alpha amylase available from DuPont. The xylanase was ROHALASE SEP brand xylanase available from AB Enzymes. The graphs of FIG. 3 shows that the xylanase treatment, and the amylase and xylanase treatments were able to make the dp2-dp10+ oligosaccharides from the Navy beans increase and soluble, but not increase the total sugar content. FIG. 3 illustrates, for each incubation time in minutes, the Total Dp2-Dp10+ content on the left and the total sugars on the right.

### EXAMPLE 4

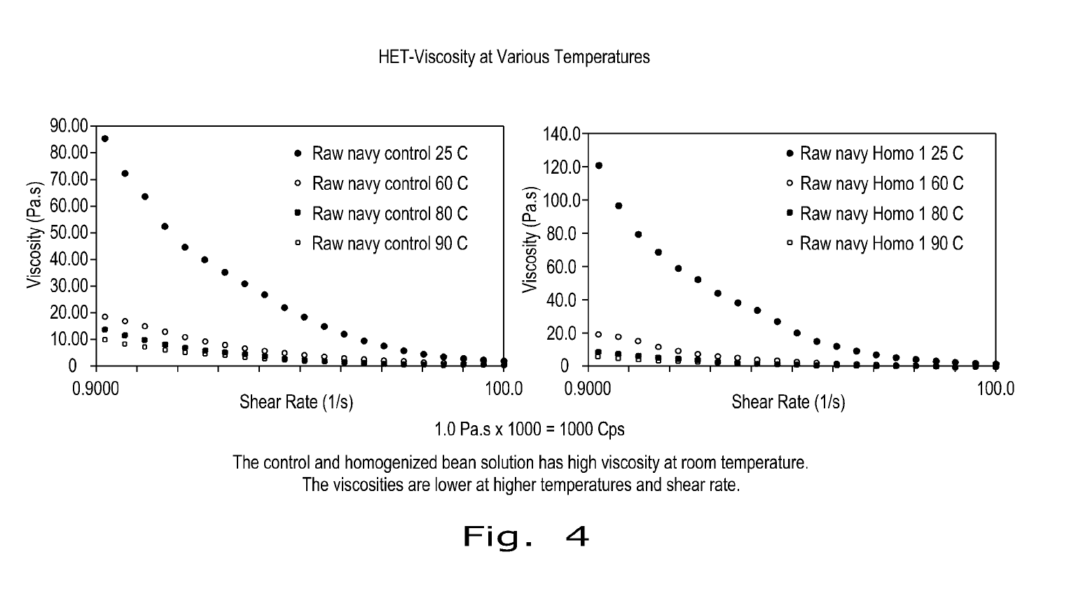

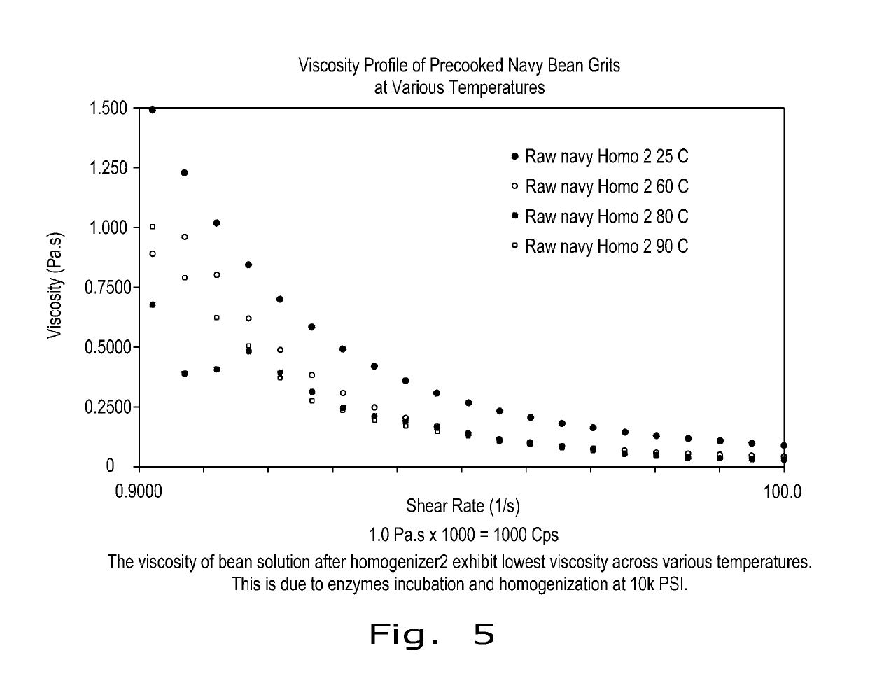

Samples were taken at various times of the process of Example 2 and viscosities were determined. FIG. 4 shows the viscosity of the raw, Navy bean product before homogenization (i.e., the control) and the viscosity of the raw, Navy bean product after the first homogenization of FIG. 1. The viscosities were determined at various temperatures. FIG. 5 shows the viscosity of the raw, Navy bean product after the second homogenization of FIG. 1. As can be seen from the graphs of FIGS. 4 and 5, the viscosity after the second homogenization and enzyme treatment reduces the viscosity of the raw, Navy bean product.

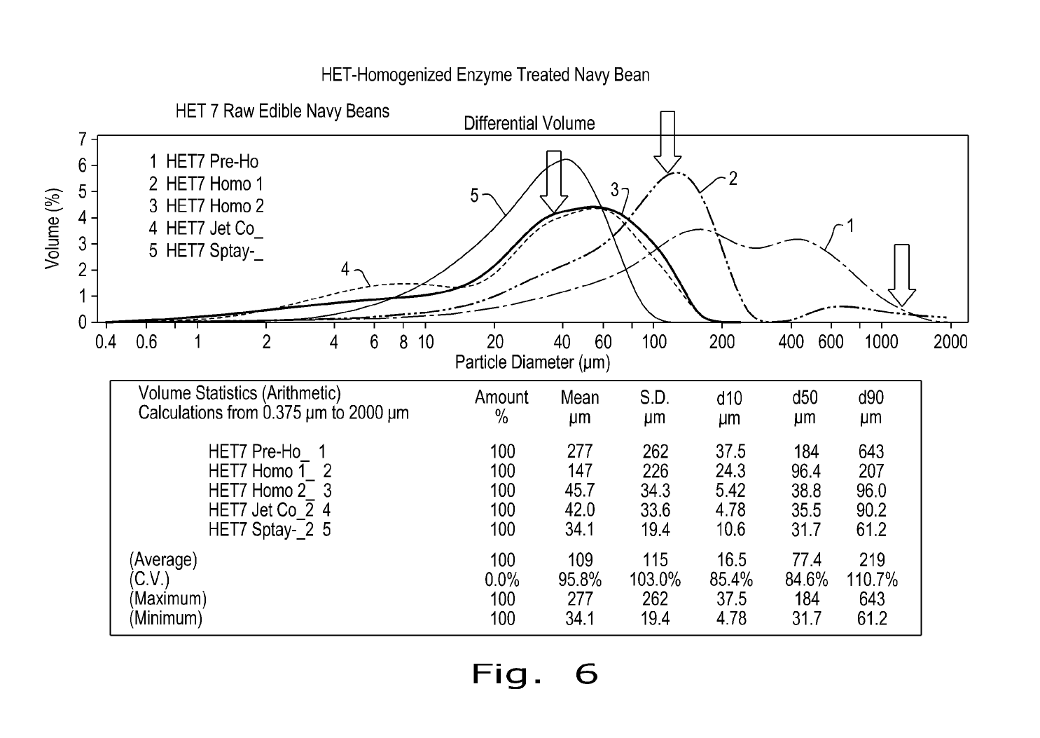

Samples of raw, Navy beans were also taken during various points of the process of FIG. 1 and particle size analysis was performed. The results are shown in FIG. 6. The particle size distribution is shown in the graph and the mean particle size is presented in the table of FIG. 6. The mean particle size decreases throughout of the process.

### EXAMPLE 5

The enzyme modified, Navy bean powder produced in accordance with Example 2 has the following nutritional information: about 4.21% moisture; about 21.3% protein; about 3% fat, about 67.5% carbohydrate; about 4% ash; and about 95% of the particles will pass through a #80 sieve. The enzyme modified, Navy bean powder also has the following nutritional characteristics per 100 g of dry product: about 382 calories; 3 g total fat; 67.5 g of total carbohydrate; 46.8 g of available carbohydrates; 20.7 g of dietary fiber; 7 g of soluble fiber; 13.7 g of insoluble fiber; 2.26 g of total sugar; and 21 g of protein. The enzyme modified, Navy bean powder has a cup density of about 0.523 g/mL; a bulk density of about 0.567 g/mL; and a tapped density of about 0.810 g/mL after about 500 taps.

On a dry basis, the enzyme modified, Navy bean powder of the present invention has different functionality as compared to dehydrated, whole Navy bean powder available under the brand VEGEFULL from Archer-Daniels-Midland Company, of Decatur, Ill. The enzyme modified, Navy bean powder also has a different nutritional profile as compared to the dehydrated, whole Navy bean powder which has, on a dry basis, per 100 g: 310 calories; 66 g of total carbohydrates; 48 g of available carbohydrates; 23 g of dietary fiber; 5 g of soluble fiber; 18 grams of insoluble fiber; 4.5 g of total sugar; and 22 g of total protein.

### EXAMPLE 6

The color of the enzyme modified, Navy bean powder produced in accordance with Example 2 was also determined. Such color was compared to a precooked, Navy bean powder available under the name VEGEFULL, available from Archer-Daniels-Midland Company, Decatur, Ill. The comparison is shown in FIG.

### EXAMPLE 7

The enzyme modified, Navy bean powder produced according to Example 2 was also evaluated for use in different food stuffs. Table 1 describes various compositions that were prepared including various amounts of the enzyme modified, Navy bean powder. Each composition has a different viscosity and may have various target applications as depicted in the Table.

TABLE 1

| | | Amount of | | Concen- | | Viscosity |
|---|---|---|---|---|---|---|
| Protein | | Navy bean | | tration per | Target | @15 RPM |
| Content | | powder | | 250 mL | Application | 4° C. (CPs) |
| 3 | grams | 14.28 | grams | 5.71% | Beverage, | 77 |
| | | | | | dairy and | |
| | | | | | soup | |
| 5 | grams | 23.8 | grams | 9.52% | Beverage, | 2959 |
| | | | | | dairy, soup, | |
| | | | | | batter | |
| 7.5 | grams | 35.71 | grams | 14.28% | Dips, dairy, | 9868 |
| | | | | | soup | |

### EXAMPLE 8

An enzyme modified, homogenized Navy bean product produced according to an embodiment of the present invention has utility as an ingredient or component of a food fed to persons suffering with dysphagia. Dysphagia is difficulty with swallowing and may be caused by old age and related health complications (i.e., dementia). Dysphagia may also be a result of a medical condition such as stroke, neurological related disease, head/neck/spinal injury, Parkinson's disease, multiple sclerosis, Alzheimer's, or other medical condition. Dysphagia is thought to affect up to 219 million persons worldwide including 15 million in the United States, where up to 1 million dysphagia patients are hospitalized each year in the United States. If dysphagia is not treated properly, there is a risk of aspiration, dehydration, poor nutrition, and less enjoyment of foods.

Treatment of dysphagia includes preparing thickened liquids that may be consumed. Depending on the severity of the dysphagia, thickened liquids may be prepared such as thin liquids with a viscosity of 1-50 mPa, nectar-like liquids with a viscosity of 51-350 mPa, honey-like liquids with a viscosity of 351-1750 mPa, and spoon-thick liquids with a viscosity of more than 1750 mPa.

The enzyme modified, homogenized pulse products of the present invention typically have a reduced viscosity compared to the pulses from which they are prepared. For instance, the enzyme modified, homogenized Navy bean products have a lower viscosity than the non-enzyme modified, non-homogenized Navy bean counterparts. Thus, such reduced viscosity can be manipulated to be suitable to be fed to a person suffering from dysphagia. Further, since food products containing the enzyme modified, homogenized pulse products of the present invention have excellent nutrition profiles, food products including the enzyme modified, homogenized food products of the present invention are good sources of protein and fiber, two nutrients of which may be difficult to consume in a liquid diet.

Examples of foods that may include the pulse products of the present invention include, but are not limited to, beverages, soup, batter, dips, dairy substitutes, or any other food product.

In an embodiment, an enzyme modified, homogenized Navy bean product of the present invention may be incorporated into a composition and configured to have a viscosity suitable for feeding to a patient suffering from dysphagia. The enzyme modified, homogenized Navy bean product may be fed by itself to the patient suffering from dysphagia or combined with other food ingredients such as pre-gel starches (i.e., yellow dent corn starch), starch maltodextrins, xanthan gum, grain based powders, purees, or combinations of any thereof. Such ingredients may be agglomerated into a dry mix, which may be subsequently pre-hydrated to a desired consistency for feeding to the patient suffering from dysphagia. The enzyme modified, homogenized food products of the present invention are able to be uniformly dispersed in water or other aqueous based liquids and formed into a powder, liquid, or puree.

The present invention has been described with reference to certain exemplary embodiments, compositions, and uses thereof. However, it will be recognized by those of ordinary skill in the art that various substitutions, modifications or combinations of any of the exemplary embodiments may be made without departing from the spirit and scope of the invention. Thus, the invention is not limited by the description of the exemplary embodiment, but rather by the appended claims as originally filed.

What is claimed is:

1. A process for producing a product, the process comprising:
homogenizing a slurry comprising water and a comminuted pulse; and
mixing an enzyme with the slurry.

2. The process of claim 1, further comprising inactivating the enzyme by heating the enzyme and the slurry to a temperature of at least 70° C., at least 72° C., at least 74° C., at least 75° C., at least 76° C., at least 80° C., at least 85° C., at least 90° C., at least 93° C., or at least 95° C.

3. (canceled)

4. The process of claim 1, further comprising drying the slurry to a powder.

5. (canceled)

6. The process of claim 1, wherein the comminuted pulse is present in the slurry at 5-50% solids, 10-40% solids, 15-35% solids, 15-25% solids, or 10-15% solids.

7. The process of claim 1, wherein the homogenizing takes place ata under pressure of 2,000-15,000 psi, 5,000-10,000 psi, 8,000-10,000 psi, or about 10,000 psi.

8. (canceled)

9. The process of claim 1, further comprising mixing a second enzyme with the slurry, wherein the second enzyme is different than the enzyme.

10. (canceled)

11. The process of claim 1 any one of claims 1 10, further comprising incubating the slurry and the enzyme for at least 5 minutes, at least 15 minutes, at least 25 minutes, at least 35 minutes, at least 45 minutes, at least 55 minutes, at least 65 minutes, at least 75 minutes, at least 85 minutes, between 45-135 minutes, between 55-125 minutes, between 65-115 minutes, between 75-105 minutes, between 85-95 minutes, or about 90 minutes, and at a temperature of at least 35° C., at least 45° C., at least 55° C., 55-57° C. at least 65° C., between 50-90° C., 60-80° C., or about 70° C.

12-13. (canceled)

14. The process of claim 1, wherein the enzyme has alpha-amylase activity.

15-17. (canceled)

18. The process of claim 1, further comprising holding the slurry and the enzyme at a temperature between 30-70° C., between 35-65° C., between 40-60° C., between 45-55° C., or about 50° C.

19. (canceled)

20. The process of claim 4, wherein the drying the slurry to the powder comprises spray draying.

21-24. (canceled)

25. The process of claim 1, further comprising homogenizing a second composition with the water and the comminuted pulse.

26. (canceled)

27. The process of claim 1, further comprising filtering the slurry.

28. The process of claim 1, wherein the pulse is selected from the group consisting of beans of Phaseolus species, beans of Vigna species, beans of Vicia species, peas, chickpeas, lentils, and combinations of any thereof.

29. The process of claim 25, wherein the second composition is selected from the group consisting of a product of wheat, oat, sorghum, an ancient grain, corn, buckwheat, quinoa, chia, rice, barley, millet, rye, triticale, fonio, teff, wild rice, spelt, einkorn, emmer, durum, kamut, and combinations of any thereof.

30. (canceled)

31. A process for producing a pulse product, comprising:
producing a slurry with a comminuted pulse and water;
cooking the slurry;
homogenizing the slurry;
mixing an enzyme with the slurry; and
inactivating the enzyme mixed with the slurry.

32. The process of claim 31, further comprising drying the slurry to a powder.

33. The process of claim 31 or claim 32, further comprising mixing a second enzyme with the slurry, wherein the second enzyme has a different activity than the enzyme.

34. (canceled)

35. The process of claim 31, wherein the enzyme has an amylase activity.

36. The process of claim 33, wherein the second enzyme has a xylanase activity.

37-41. (canceled)

42. The process of claim 31, further comprising filtering the slurry.

43-50. (canceled)
